(19) United States
(12) Patent Application Publication
(10) Pub. No.: US 2025/0303830 A1
(43) Pub. Date: Oct. 2, 2025

(54) SIDE DOOR STRUCTURE

(71) Applicant: SUBARU CORPORATION, Tokyo (JP)

(72) Inventors: Mitsuhiro IWAMOTO, Tokyo (JP); Kazuhiro FUKAMACHI, Tokyo (JP)

(21) Appl. No.: 19/041,747

(22) Filed: Jan. 30, 2025

(30) Foreign Application Priority Data
Mar. 26, 2024 (JP) 2024-050373

(51) Int. Cl. B60J 5/04; B60L 50/60; B60R 13/07; H01M 50/242; H01M 50/249

(52) U.S. Cl. CPC B60J 5/0427; B60J 5/0413; B60J 5/0415; B60R 13/07; H01M 50/242; H01M 50/249; B60L 50/66; H01M 2220/20

(57) ABSTRACT

A side door structure includes an inner panel, an outer panel, a drain hole, and an impact absorbing member. The inner panel covers a vehicle-widthwise outer side of a side sill extending in a front-rear direction of a vehicle body of a vehicle. The outer panel is disposed at a position facing the inner panel and joined, at an edge part of the outer panel, to the inner panel to constitute a side door of the vehicle together with the inner panel. The drain hole is provided in a lower end part of the inner panel. The drain hole is designed to rainwater entering an internal space of the side door from an outside of the vehicle. The impact absorbing member is disposed on a vehicle-widthwise inner side of the inner panel. The impact absorbing member extends in the front-rear direction at a position facing the side sill.

### CROSS-REFERENCE TO RELATED APPLICATIONS

The present application claims priority from Japanese Patent Application No. 2024-050373 filed on Mar. 26, 2024, the entire contents of which are hereby incorporated by reference.

### BACKGROUND

The disclosure relates to a side door structure including an impact absorbing member that absorbs impact energy generated upon a collision or the like.

In recent years, a hybrid vehicle including an electric motor as a drive source in addition to a conventional internal combustion engine (engine), an electric vehicle including an electric motor as a drive source, and the like have been put into practical use in a vehicle such as an automobile.

Such a vehicle has a large rechargeable battery (hereinafter, simply abbreviated as a battery) mounted therein for driving an electric motor. Such a large battery is typically disposed on a bottom surface part of a floor panel. Additionally, side sills extending in a vehicle body front-rear direction are disposed on vehicle-widthwise opposite sides of the battery.

The side sills each have a closed cross-sectional shape in a substantially rectangular cross-section. Such side sills serve as impact absorbers that absorb impact energy and protect the battery at the time of a side collision of the vehicle.

Incidentally, part of vehicle-widthwise outer surfaces of the side sills is typically exposed to the outside of the vehicle. Dirt easily adheres to such surfaces of the side sills, which are exposed to the outside of the vehicle.

In recent years, in order to prevent such dirt from adhering to the side sills, side doors have been adopted that cover the vehicle-widthwise outer surfaces of the side sills.

The adoption of such side doors in the above-described vehicle involves a problem that spaces for disposition of the side sills are reduced, and adequate absorption of impact energy cannot be secured at the time of a side collision of the vehicle.

In response to such a problem, for example, Japanese Unexamined Patent Application Publication (JP-A) No. 2019-25935 discloses a technique related to a side door structure in which an impact absorbing member is disposed in the inside of a side door and an amount of absorption of impact energy at the time of a side collision of a vehicle can be increased.

### SUMMARY

An aspect of the disclosure provides a side door structure. The side door structure includes an inner panel, an outer panel, a drain hole, and an impact absorbing member. The inner panel covers a vehicle-widthwise outer side of a side sill extending in a vehicle body front-rear direction that is a front-rear direction of a vehicle body of a vehicle. The outer panel is disposed at a position facing the inner panel and joined, at an edge part of the outer panel, to the inner panel to constitute a side door of the vehicle together with the inner panel. The drain hole is provided in a lower end part of the inner panel. The drain hole is designed to drain rainwater entering an internal space of the side door from an outside of the vehicle. The impact absorbing member is disposed on a vehicle-widthwise inner side of the inner panel. The impact absorbing member extends in the vehicle body front-rear direction at a position facing the side sill.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a vehicle;

FIG. 2 is a perspective view illustrating a side door in an open position;

FIG. 3 is a cross-sectional view taken along line III-III of FIG. 1;

FIG. 4 is a perspective view illustrating a collision state of an impact absorbing member and a side sill at an initial stage of a pole side collision; and

FIG. 5 is a perspective view illustrating a collision state of the impact absorbing member and the side sill at a final stage of the pole side collision.

### DETAILED DESCRIPTION

An outer panel and an inner panel constituting the side door are typically joined, at a lower edge part of the side door, to each other by hemming. Thus, in a lower part of the side door, an interval between the outer panel and the inner panel is narrow.

When the impact absorbing member is disposed in a space having such a narrow interval, a shape of the impact absorbing member is limited. For example, in the technique of JP-A No. 2019-25935, the impact absorbing member has an inclined lower wall part, thereby avoiding interference between the impact absorbing member and the outer panel. Thus, in the technique of JP-A No. 2019-25935, the impact absorbing member may not be able to adequately secure a function of reinforcing rigidity of the side sill.

On the other hand, when the impact absorbing member has no inclined lower wall part, the interval between the outer panel and the impact absorbing member is markedly narrow. This may result in deteriorated drainage of rainwater or the like entering the inside of the door from the outside of the vehicle.

It is desirable to provide a side door structure capable of providing adequate rigidity reinforcement to a side sill without impairing drainage of rainwater or the like entering the inside of a door from the outside of a vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

Note that in the drawings used in conjunction with the following description, a different scale size is used for each of components in order to allow each component to be illustrated in a recognizable size in the drawings. Thus, the disclosure is in no way limited to the numerical values, shapes, and ratio of sizes of the components, and the relative positional relationship between the components illustrated in the drawings. The “join” described in the following description means any joining method performed using a joining technique represented by melt joining, mechanical joining, or the like.

As an example of a vehicle body to which a side door structure according to the present embodiment is applied, a description will be given of a vehicle body structure of a vehicle 1 such as an electric vehicle or a hybrid vehicle in which a battery 9 is mounted under a floor.

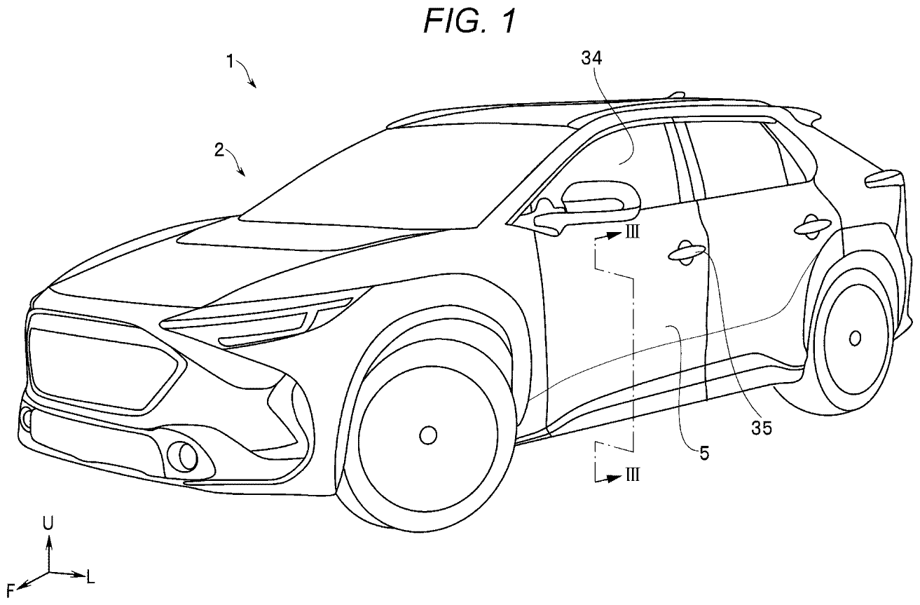

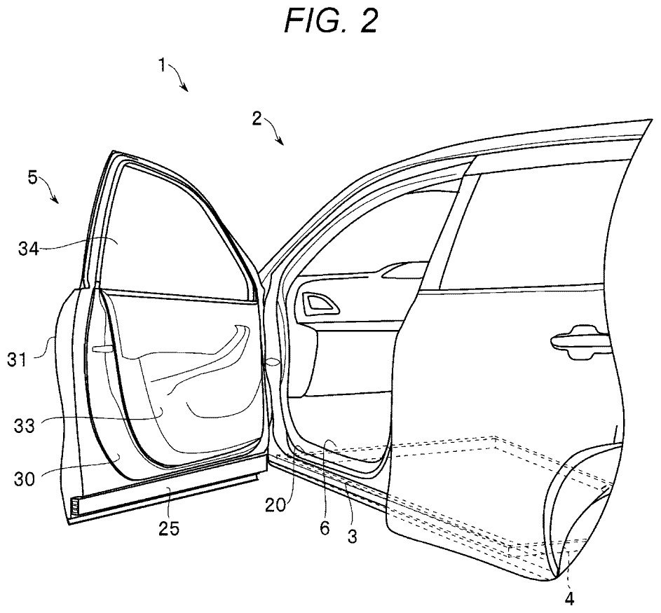

As illustrated in FIGS. 1 and 2, a vehicle body 2 of the vehicle 1 includes a side sill 3, a battery frame 4, and a front side door 5 (hereinafter, referred to as a side door 5).

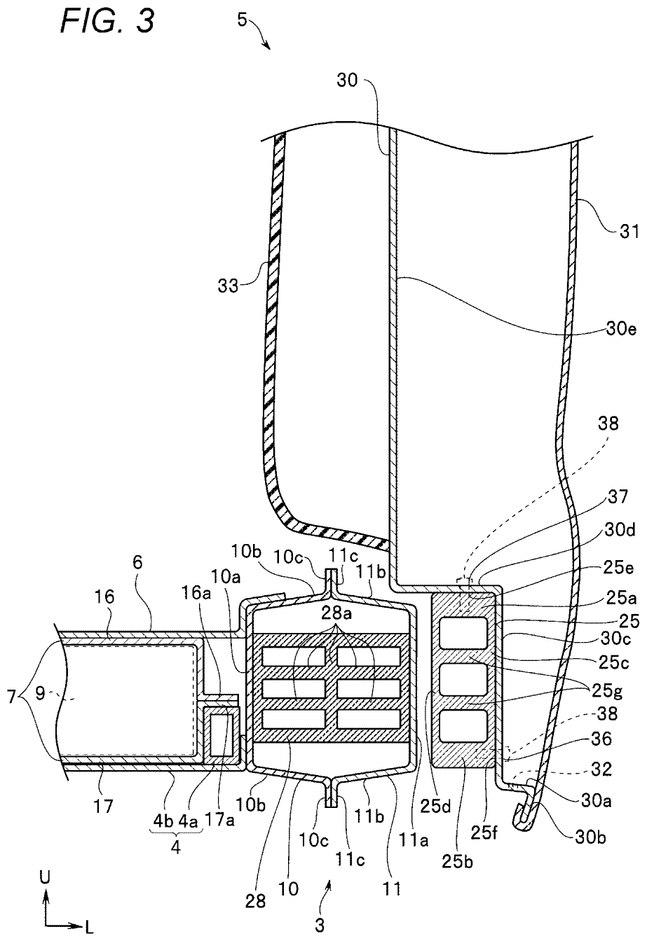

As illustrated in FIGS. 2 and 3, the side sill 3 is disposed on either side of a floor panel 6 constituting a bottom surface of a cabin. Furthermore, the side sill 3 extends along the floor panel 6 in a vehicle body front-rear direction. Such a side sill 3 is formed by pressing a sheet metal member made of a steel plate or the like.

As illustrated in FIG. 3, the side sill 3 includes an inner frame 10 and an outer frame 11.

The inner frame 10 has a substantially hat-shaped cross-sectional shape protruding vehicle-widthwise inward. Such an inner frame 10 has an inner wall part 10a, upper and lower wall parts 10b, and upper and lower inner flanges 10c.

The inner wall part 10a extends in a vehicle body up-down direction.

The upper and lower wall parts 10b respectively extend vehicle-widthwise outward from both vehicle body up-down directional ends of the inner wall part 10a.

The upper and lower inner flanges 10c respectively extend in an up-down direction from vehicle-widthwise outer edge parts of the upper and lower wall parts 10b. The upper and lower inner flanges 10c each serve as a flange for joining the inner frame 10 to the outer frame 11.

The outer frame 11 has a substantially hat-shaped cross-sectional shape protruding vehicle-widthwise outward. The outer frame 11 is disposed at a position facing a vehicle-widthwise outer side of the inner frame 10. In one example, an opening part of the outer frame 11 is disposed facing an opening part of the inner frame 10.

The outer frame 11 thus disposed includes an outer wall part 11a, upper and lower wall parts 11b, and upper and lower outer flanges 11c.

The outer wall part 11a is disposed at a position facing the inner wall part 10a.

The upper and lower wall parts 11b respectively extend vehicle-widthwise inward from both vehicle body up-down directional ends of the outer wall part 11a.

The upper and lower outer flanges 11c respectively extend in the up-down direction from vehicle-widthwise inner edge parts of the upper and lower wall parts 11b.

Such an outer frame 11 is joined to the inner frame 10 with the upper and lower outer flanges 11c being in abutment respectively with the upper and lower inner flanges 10c.

Thus, the side sill 3 has a hollow substantially rectangular cross-sectional shape.

Such a side sill 3 includes a reinforcing member 28 disposed in the internal space thereof. The reinforcing member 28 has, for example, a rectangular parallelepiped shape extending in the vehicle body front-rear direction along an inner surface of the inner wall part 10a and an inner surface of the outer wall part 11a. The reinforcing member 28 is joined, on its vehicle-widthwise opposite sides, in abutment to the inner surface of the inner wall part 10a and the inner surface of the outer wall part 11a.

Furthermore, the reinforcing member 28 includes a reinforcing part 28a in the inside thereof.

The reinforcing part 28a includes, for example, flat plates coupled in a lattice shape.

At the time of a side collision of the vehicle 1, such a reinforcing member 28 can reinforce rigidity of the side sill 3 and also absorb impact energy.

The reinforcing member 28 is, for example, an aluminum extrusion molded product.

For example, as illustrated in FIG. 3, the battery frame 4 is disposed at a predetermined interval at a position facing a bottom surface side of the floor panel 6. The battery frame 4 is also disposed on a vehicle-widthwise inner side of the side sill 3.

The battery frame 4 includes, for example, frame members 4a and a bottom plate 4b.

The frame members 4a form a rectangular frame as a whole. Each frame member 4a has a rectangular cross-sectional shape.

The bottom plate 4b is disposed on a bottom surface of a rectangular frame formed by the frame members 4a. Thus, the bottom plate 4b has a rectangular shape in plan view. For example, an outer peripheral edge part of the bottom plate 4b is bent upward along an outer edge part of a lower end part of each frame member 4a. A vehicle-widthwise outer surface of the bent outer peripheral edge part is joined to a lower part of the inner wall part 10a.

A battery case 7 can be placed on an upper surface of each frame member 4a and an upper surface of the bottom plate 4b of such a battery frame 4.

The battery case 7 includes an upper case 16 and a lower case 17.

Each of the upper and lower cases 16 and 17 is, for example, formed by pressing a sheet metal member made of a steel plate or the like. Each of the upper and lower cases 16 and 17 has, for example, a substantially hat-shaped cross-sectional shape. Thus, an outward flange part 16a and an outward flange part 17a are respectively formed at outer peripheral edge parts of the upper and lower cases 16 and 17.

Such upper and lower cases 16 and 17 are joined to each other with their opening parts facing each other and with the outward flange parts 16a and 17a being in abutment with each other. Thus, the battery case 7 has a hollow substantially rectangular cross-sectional shape.

Such a battery case 7 houses the battery 9 in the internal space thereof.

The battery 9 is, for example, a battery that supplies electric power to a motor that is a drive source of the vehicle. Such a battery 9 includes rectangular parallelepiped-shaped battery cells (not illustrated) stacked together. The battery cells each accommodate electric cells of a secondary battery including a lithium ion battery, a nickel hydrogen battery, or the like.

The battery case 7 housing such a battery 9 is joined to each frame member 4a in a state of being placed on the battery frame 4. Thus, the battery 9 is fixed at a position facing the vehicle-widthwise inner side of the side sill 3.

As illustrated in FIG. 2, the side door 5 is, for example, a swing door swingable in the vehicle width direction of the vehicle body 2. Thus, a front part of the side door 5 is supported at a front part of a door opening part 20 via upper and lower hinges (not illustrated). The side door 5 is configured to cover the vehicle-widthwise outer side of the side sill 3 when closing the door opening part 20. That is, the lower part of the side door 5 is positioned to face the vehicle-widthwise outer side of the side sill 3.

As illustrated in FIGS. 2 and 3, such a side door 5 includes an inner panel 30 and an outer panel 31. Note that in the following description, the disposition of each component of the side door 5 is disposition in a state where the side door 5 closes the door opening part 20.

The inner panel 30 is formed by pressing a sheet metal member made of a steel plate or the like. The inner panel 30 is disposed on a vehicle-widthwise inner side of the side door 5. A lower part of the inner panel 30 is disposed to cover the outer wall part 11a of the side sill 3.

In one detailed example, the inner panel 30 includes a lower wall part 30a, a first side wall part 30c, a stepped part 30d, and a second side wall part 30e.

The lower wall part 30a is formed at a lower end part of the inner panel 30. The lower wall part 30a extends in the vehicle width direction. The lower wall part 30a has a drain hole 32 in a substantially central part thereof in the vehicle width direction. The drain hole 32 is disposed for draining, to the outside of the vehicle, rainwater or the like entering the internal space of the side door 5 from the outside of the vehicle. Drain holes 32 are disposed in the vehicle body front-rear direction of the side door 5.

An outward flange part 30b extending in a state of being bent downward is formed at a vehicle-widthwise outer edge part of such a lower wall part 30a. The outward flange part 30b forms a front edge part, a rear edge part, and a lower edge part of the inner panel 30.

The first side wall part 30c extends upward from a vehicle-widthwise inner edge part of the lower wall part 30a. The first side wall part 30c is formed at a predetermined interval at a position facing the outer wall part 11a of the outer frame 11. Furthermore, the first side wall part 30c has, in its lower part, bolt insertion holes 36 at predetermined intervals in the vehicle body front-rear direction.

The stepped part 30d extends vehicle-widthwise inward from an upper edge part of the first side wall part 30c. The stepped part 30d has, in an area near the vehicle-widthwise center part thereof, bolt insertion holes 37 at predetermined intervals in the vehicle body front-rear direction.

The second side wall part 30e extends upward from the vehicle-widthwise inner edge part of the stepped part 30d. A resin trim panel 33 is disposed on an outer surface of the second side wall part 30e on the vehicle-widthwise inner side.

With such a configuration, in the lower part of the inner panel 30, a space for attachment of an impact absorbing member 25 (to be described later) is provided at a position facing the vehicle-widthwise outer side of the side sill 3.

The outer panel 31 is formed by pressing a sheet metal member made of a steel plate or the like. The outer panel 31 is disposed on a vehicle-widthwise outer side of the side door 5. A front edge part, a rear edge part, and a lower edge part of the outer panel 31 are joined to the outward flange part 30b of the inner panel 30 by hemming or the like.

Here, an interval between the first side wall part 30c and the outer panel 31 is set to a dimension such that at least rainwater or the like that has entered the inside of the side door 5 can be drained to the outside of the vehicle.

Through such joining of the inner panel 30 and the outer panel 31, the side door 5 has an internal space.

Upper edge parts of the inner panel 30 and the outer panel 31 face each other and are bent toward the inside of the side door 5. An upper surface of the side door 5 has an opening part (not illustrated) through which a window glass 34 enters and exits.

Furthermore, a door handle 35 is attached to the outer panel 31 near the rear part on the outer surface side of the outer panel 31. The door handle 35 is coupled, inside the side door 5, to a ratchet mechanism via a rod (neither is illustrated).

The impact absorbing member 25 is disposed on the outside of the side door 5 thus configured. The impact absorbing member 25 absorbs impact energy upon a side collision of the vehicle 1.

The impact absorbing member 25 is disposed on the vehicle-widthwise inner side of the inner panel 30. The impact absorbing member 25 extends in the vehicle body front-rear direction at a position facing the side sill 3. Such an impact absorbing member 25 has a rectangular parallelepiped shape extending in the vehicle body front-rear direction.

In one detailed example, as illustrated in FIG. 3, the impact absorbing member 25 includes an upper wall part 25a, a lower wall part 25b, an outer wall part 25c, and an inner wall part 25d.

The upper wall part 25a and the lower wall part 25b face each other at a predetermined interval in the up-down direction.

The upper wall part 25a has, in a substantially central part thereof, bolt insertion recesses 25e at predetermined intervals in the vehicle body front-rear direction. The lower wall part 25b has, on the vehicle-widthwise outer side thereof, bolt insertion recesses 25f at predetermined intervals in the vehicle body front-rear direction.

The outer wall part 25c and the inner wall part 25d face each other at a predetermined interval in the vehicle width direction.

Upper end parts of the outer wall part 25c and the inner wall part 25d are coupled to each other by the upper wall part 25a. Lower end parts of the outer wall part 25c and the inner wall part 25d are coupled to each other by the lower wall part 25b.

Consequently, the upper wall part 25a, the lower wall part 25b, the outer wall part 25c, and the inner wall part 25d form a hollow rectangular cross-sectional shape.

The impact absorbing member 25 thus formed includes reinforcing plates 25g in the internal space thereof. The reinforcing plates 25g each have, for example, a flat plate shape extending in the vehicle width direction.

In one example, the reinforcing plates 25g (e.g., two in the present embodiment) are disposed so as to partition the internal space of the impact absorbing member 25 in the vehicle body up-down direction.

Such reinforcing plates 25g reinforce rigidity of the impact absorbing member 25 at the time of a side collision of the vehicle 1. Additionally, the reinforcing plates 25g can be deformed together with the impact absorbing member 25 to absorb impact energy at the time of the side collision of the vehicle 1. Note that, in order to accurately absorb the impact energy, various conditions such as the plate thickness of the reinforcing plate 25g and the number of the reinforcing plates 25g disposed inside the impact absorbing member 25 are determined in advance from experiments, simulations, and the like. Furthermore, the reinforcing plates 25g may be disposed inside the impact absorbing member 25 in a lattice shape. The impact absorbing member 25 including these reinforcing plates 25g inside is, for example, an aluminum extrusion molded product.

With such a configuration, the impact absorbing member 25 can be joined to the lower part of the inner panel 30 at the position facing the side sill 3.

In one detailed example, the upper wall part 25a and the outer wall part 25c are respectively in abutment with the stepped part 30d and the first side wall part 30c.

The bolt insertion recesses 25e and 25f are respectively aligned with the bolt insertion holes 37 and 36.

A bolt 38 is screwed from the inside of the side door 5 into each of the bolt insertion holes 37 and 36 respectively aligned with the bolt insertion recesses 25e and 25f.

With this, the impact absorbing member 25 can be joined, by bolt fastening, to the lower part of the inner panel 30 at the position facing the side sill 3. Note that, the joining of the impact absorbing member 25 to the inner panel 30 is not limited to the bolt fastening, and may be joining by an adhesive, welding, or the like.

According to such an embodiment, the side door structure includes the inner panel 30, the outer panel 31, the drain hole 32, and the impact absorbing member 25. The inner panel 30 covers the vehicle-widthwise outer side of the side sill 3 extending in the vehicle body front-rear direction. The outer panel 31 is disposed at a position facing the inner panel 30 and joined, at an edge part of the outer panel 31, to the inner panel 30 to constitute the side door 5 together with the inner panel 30. The drain hole 32 is provided in the lower end part of the inner panel 30. The drain hole 32 allows rainwater entering the internal space of the side door 5 from the outside of the vehicle to drain. The impact absorbing member 25 is disposed on the vehicle-widthwise inner side of the inner panel 30. The impact absorbing member 25 extends in the vehicle body front-rear direction at the position facing the side sill 3. With these configurations, the side door structure can provide adequate rigidity reinforcement to the side sill 3 without impairing drainage of rainwater or the like entering the inside of the door from the outside of the vehicle.

That is, the side door 5 includes the impact absorbing member 25 on the vehicle-widthwise inner side of the inner panel 30. In other words, the impact absorbing member 25 is disposed on the outside of the side door 5 so as not to interfere with the flow of rainwater or the like entering the inside of the side door 5. Thus, the side door 5 allows rainwater or the like that has entered the inside of the side door 5 to be quickly guided to the drain hole 32.

Additionally, the impact absorbing member 25 is disposed at the position facing the side sill 3 on the outside of the side door 5. Consequently, the shape of the impact absorbing member 25 can be set with high flexibility without being restricted by the internal space of the lower part of the side door 5. Thus, the shape of the impact absorbing member 25 can be set to an optimum shape for reinforcing the rigidity of the side sill 3.

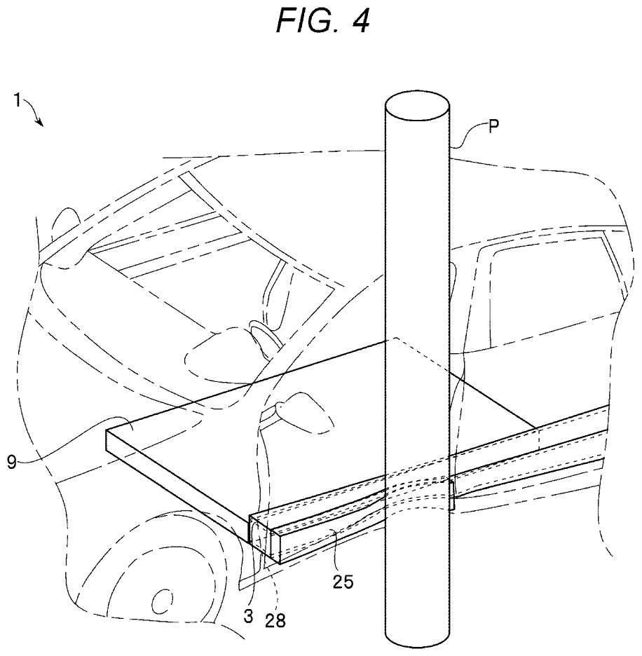

Consequently, for example, upon a pole side collision in which a collision load from a utility pole or the like (pole P) is locally concentrated and input to the side surface of the vehicle 1, the impact absorbing member 25 can accurately absorb impact energy at an initial stage of the collision. As a result, a deformation stroke of the side sill 3 can be reduced (see FIG. 4).

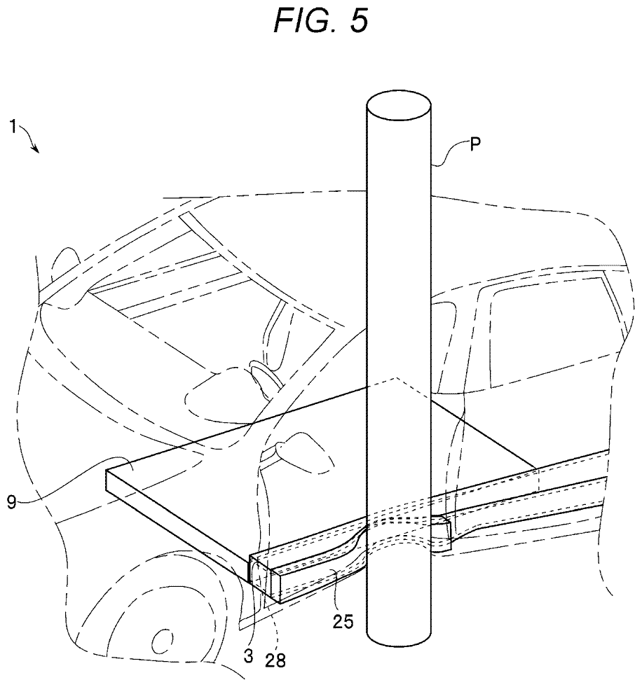

Furthermore, since the deformation stroke of the side sill 3 at the initial stage of the collision is reduced, the side sill 3 can accurately absorb impact energy at a final stage of the collision without greatly deforming vehicle-widthwise inward (see FIG. 5). Thus, for example, even when the battery 9 is mounted under the floor of the vehicle 1, the battery 9 can be accurately protected from the pole side collision or the like.

In this case, forming the impact absorbing member 25 into a substantially rectangular cross-sectional shape can effectively enhance the rigidity of the impact absorbing member 25.

Additionally, the provision of the reinforcing plates 25g inside the impact absorbing member 25 can further enhance the impact absorption efficiency of the impact absorbing member 25.

The present embodiment has described the example in which the impact absorbing member 25 is applied to the front side door 5 of the vehicle 1. However, the impact absorbing member 25 can also be applied to a rear side door of the vehicle 1.

Note that, the disclosure described in the embodiment described above is not limited to the embodiment and various modifications may be made without departing from the scope of the disclosure in the implementation stage.

Additionally, the embodiment described above includes various stages of the disclosure, and the constituent elements disclosed herein may be appropriately combined to provide various disclosures.

Furthermore, even if some constituent elements described in the embodiment described above are removed, the resulting components, with the constituent elements removed, can still provide the disclosure, as long as the problems described above can be solved and the effects described above can be achieved.

1. A side door structure comprising:
an inner panel covering a vehicle-widthwise outer side of a side sill extending in a vehicle body front-rear direction that is a front-rear direction of a vehicle body of a vehicle;
an outer panel disposed at a position facing the inner panel and joined, at an edge part of the outer panel, to the inner panel to constitute a side door of the vehicle together with the inner panel;
a drain hole provided in a lower end part of the inner panel, the drain hole being designed to drain rainwater entering an internal space of the side door from an outside of the vehicle; and
an impact absorbing member disposed on a vehicle-widthwise inner side of the inner panel, the impact absorbing member extending in the vehicle body front-rear direction at a position facing the side sill.

2. The side door structure according to claim 1, wherein the impact absorbing member has a substantially rectangular cross-sectional shape.

3. The side door structure according to claim 1, wherein the impact absorbing member comprises a reinforcing plate inside of the impact absorbing member.

4. The side door structure according to claim 1, wherein
in the vehicle to which the side door structure is applied, a battery is mounted on a vehicle-widthwise inner side of the side sill, and
the impact absorbing member is disposed at a position facing the battery with the side sill interposed between the impact absorbing member and the battery.
